(19) United States
(12) Patent Application Publication
(10) Pub. No.: US 2014/0305924 A1
(43) Pub. Date: Oct. 16, 2014

(54) Heatable Current Collector for Establishing an Electrical Contact Between a Current Carrying Line and an Electric Vehicle

(71) Applicant: Thermo Heating Elements GmbH, Rohrbach (DE)

(72) Inventor: Paul Uchtmann, Greer, SC (US)

(73) Assignee: Thermo Heating Elements GmbH, Rohrbach (DE)

(21) Appl. No.: 14/244,563

(22) Filed: Apr. 3, 2014

(30) Foreign Application Priority Data
Apr. 16, 2013 (DE) 202013101624.1

(51) Int. Cl. B60L 5/02; H05B 3/14

(52) U.S. Cl. CPC B60L 5/02; H05B 3/146
USPC 219/202; 219/535

(57) ABSTRACT

A heatable current collector for establishing an electrical contact between a current carrying line and an electric vehicle includes a lifting mechanism, a sliding contact rail, a rod, an electrical resistance heating conductor and a resilient hose. The rail is mounted on the lifting mechanism and has a longitudinal hole disposed perpendicular to the current carrying line. The electrical resistance heating conductor is disposed in grooves of an outer threading of the rod. One end of the resilient hose is sealed off and is connected to an end of the rod. The rod, the electrical resistance heating conductor and the resilient hose are disposed in the hole. The resilient hose presses the rod and the electrical resistance heating conductor against an inside surface of the hole. The hole is formed so close beneath a surface of the rail that a section of the hole forms a slit in the surface.

### CROSS REFERENCE TO RELATED APPLICATION

This application is based on and hereby claims the benefit under 35 U.S.C. §119 from German Patent Application No. DE 202013101624.1, filed on Apr. 16, 2013, in the German Patent Office. This application is a continuation-in-part of German Patent Application No. DE 202013101624.1, the contents of which are incorporated herein by reference.

### TECHNICAL FIELD

The present invention relates to a heatable current collector for establishing an electrical contact between a current carrying line and an electric vehicle as well as to a heating device for use in the heatable current collector.

### BACKGROUND

Current collectors of electric vehicles, such as electrically operated locomotives and streetcars, as well as current carrying lines, such as overhead railway lines for supplying electric vehicles with electrical current for operating the vehicles, are exposed to the effects of weather. A frost or ice layer can form on the current collector or on the current carrying line and interfere with or even prevent the electrical contact between the current collector and the line. Devices are known for de-icing outdoor wire lines that beat the wires, expose the wires to a long lasting uninterrupted vibration, or heat the wires by short-circuiting certain sections of the line. A disadvantage of devices that beat or vibrate the wires is that the lifespan of the line wires is shortened. A disadvantage of devices that heat the wires is that they have to be very powerful, and the operation of electric vehicles has to be interrupted while the section of a line is short-circuited. The German Patent No. DE2324387 discloses a de-icing device for de-icing the surfaces of exposed line wires that is supported by a lifting mechanism arranged on the roof of an electric vehicle. The de-icing device includes a means, in particular an inductor, for generating pulses of an electric field at time intervals. The means is arranged in the immediate vicinity of the surface to be de-iced and causes a resilient deformation of the surface so that the ice layer is chipped off. A disadvantage of this de-icing device is that it only effectively removes an ice layer but not a frost layer.

German Utility Model DE7029001 discloses a current collector for a crane that can be moved along a current rail and that has a sliding body applied against the current rail for establishing an electrical contact with the current rail. The sliding body has bored holes that are formed in a direction perpendicular to the current rail. A heating cartridge can be inserted into each of the bored holes. When a frost or ice layer forms on the current rail, an electrical current is supplied to the heating cartridge, which becomes warm and heats the sliding body and the current rail in the vicinity of the heating contact site between the sliding body and the current rail. A disadvantage of this solution is that the diameter of the bored hole must be sufficiently large so as to accommodate the heating cartridge in a heated and consequently thermally expanded state. When the heating cartridge is in a comparatively colder state, it contacts the inner surface of the bored hole only in a limited area in a support surface of the heating cartridge as opposed to ideally contacting the full surface of the bored hole around the heating cartridge, which would be desirable for an optimal heat transfer from the heating cartridge to the inner surface of the bored hole. It is also disadvantageous that the heating device in a colder state is not firmly connected to the inner surface of the bored hole. Due to the air gap between the surface of the heating cartridge and the inner surface of the bored hole, there is poor thermal contact with the inner surface of the bored hole. Furthermore, there is the disadvantage that the heating cartridge used in the colder state can rotate and/or be axially shifted in the bored hole.

A de-icing device is sought that solves the problems associated with heatable current collectors having bored holes that receive heating devices. A heating device is sought that can easily be inserted into a bored hole and secured after its insertion.

### SUMMARY

A heatable current collector for establishing an electrical contact between a current carrying line and an electric vehicle includes a sliding contact rail arranged substantially transversely to the current carrying line. The sliding contact rail has a bored hole in which an electrically operated, elongated heating element is disposed. The heating element occupies only a portion of the cross section of the bored hole. The heating element is connected to a clamping device that presses the heating element against the inside surface of the bored hole. A heating device for the heatable current collector has a substantially rigid, rod-shaped heating element with an electrical resistance heating conductor and two free ends. The heating device includes an inherently stable, resilient and thermostable hose that is sealed off at one end. The sealed off end of the hose is firmly connected to one of the free ends of the heating element.

In another embodiment, the heatable current collector for establishing an electrical contact between a current carrying line and an electric vehicle includes a lifting mechanism, a sliding contact rail, a rod, an electrical resistance heating conductor, and insulating layer and a resilient hose. The sliding contact rail is mounted on the lifting mechanism and has a hole disposed longitudinally through the rail and perpendicular to the current carrying line. The electrical resistance heating conductor is helically arranged in grooves of an outer threading of the rod. The insulating layer is a shrink hose that covers the rod and the electrical resistance heating conductor. The insulating layer is electrically insulating and heat permeable. One end of the resilient hose is sealed off and is connected to an end of the rod. The rod, the electrical resistance heating conductor, the insulating layer and the resilient hose are disposed in the hole. The rod, the electrical resistance heating conductor and the insulating layer occupy only a portion of the cross section of the hole. The resilient hose presses the rod, the electrical resistance heating conductor and the insulating layer against the inside surface of the hole.

The hole in the sliding contact rail is formed so close beneath a surface of the rail that faces the current carrying line that a section of the hole forms a slit in the surface facing the line. The resilient hose is disposed in the hole opposite the rod and pushes the rod, the electrical resistance heating conductor and the insulating layer towards the slit. The slit has a width that is smaller than the diameter of the rod.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a side view of a first embodiment of a current collector in contact with a current carrying line.

FIG. 2 is a perspective view of a second embodiment example of a current collector in contact with the current carrying line.

FIG. 3 is a cross sectional view of the sliding contact rail of the current collector of FIG. 2 in more detail shown perpendicular to the longitudinal direction of the sliding contact rail.

FIG. 4 shows another embodiment similar to the sliding contact rail of FIG. 3.

FIG. 5 is a cross sectional view of a heating device arranged in a bored hole of a sliding contact rail shown perpendicular to the longitudinal direction of the sliding contact rail.

FIG. 6 shows another embodiment similar to the heating device of FIG. 5 in the bored hole of a sliding contact rail.

FIG. 7 is a cross sectional view of a sliding contact rail of a current collector in contact with two current carrying lines shown along the longitudinal direction of the sliding contact rail.

FIG. 8 shows a heating device before being incorporated into a current collector.

FIG. 9 is a cross sectional view of the heating device of FIG. 8 at a free end shown along the longitudinal axis of the heating element and the hose.

FIG. 10 is a cross sectional view of the heating device of FIG. 8 at the other free end shown along the longitudinal axis of the heating element and the hose.

### DETAILED DESCRIPTION

Reference will now be made in detail to some embodiments of the invention, examples of which are illustrated in the accompanying drawings.

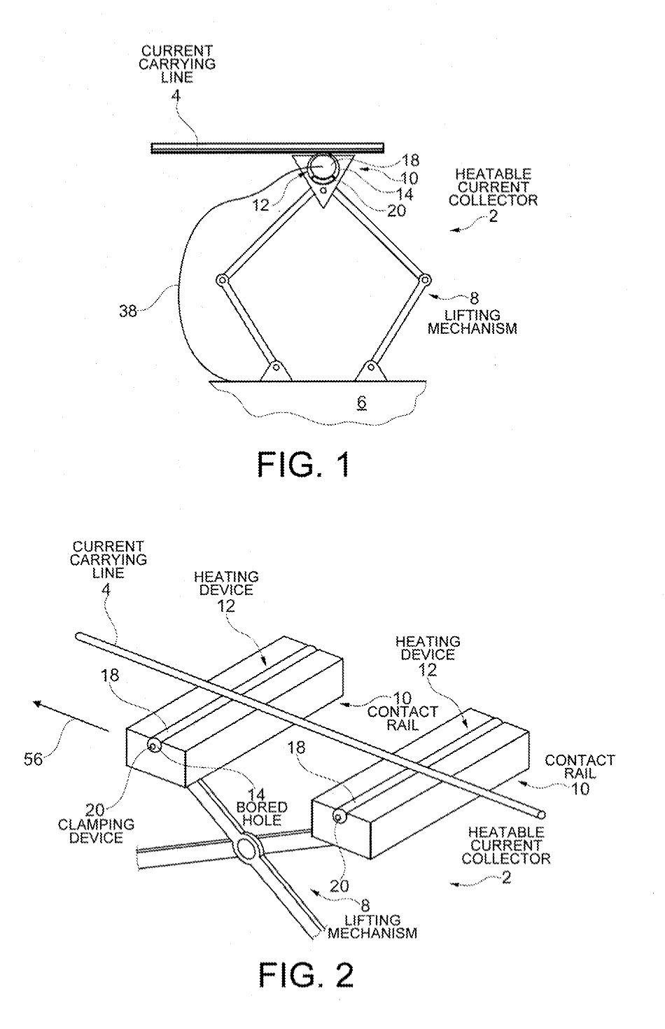

FIG. 1 shows a heatable current collector 2 for establishing an electrical contact between a current carrying line 4 and an electric vehicle 6. The current collector 2 includes a sliding contact rail 10 arranged substantially transversely to the current carrying line 4 and a lifting mechanism 8 on which the sliding contact rail 10 is mounted. The sliding contact rail 10 has a bored hole 14 in which in each case an electrically operated, elongated heating element 18 is disposed that occupies only a portion of the cross section of the bored hole 14. The bored hole 14 in rail 10 need not be bored or drilled, but rather can alternatively be cast or molded.

The heating element 18 is connected to a clamping device 20 that presses the heating element 18 against the inside surface 16 of the bored hole 14. The clamping device 20 secures the heating element 18 inside the bored hole 14. By pressing the heating element 18 against the inside surface 16 of the bored hole 14, the heat transfer from the heating element 18 to the inside surface 16 of the bored hole 14 is improved.

In one embodiment, the clamping device 20 is an inherently stable, resilient and thermostable hose 22. Due to its inherent stability, the hose 22 can also be easily introduced into the bored hole 14. Due to its resilience, the hose 22 takes on shape changes (expansion and contraction) of the heating element 18 that occur due to temperature changes. The resilience of the hose 22 improves heat transfer from the heating element 18 to the inside surface 16 of the bored hole 14 by ensuring that the heating element 18 is pressed against the inside surface 16 of the bored hole 14 even at different temperatures or in the event of different shapes of the heating element 18. Due to its thermostability, the hose 22 maintains its functionality even at the high temperatures that occur during the heating operation of the heating element 18.

The heating element 18 is designed as a substantially rigid rod 28 with two free ends. Due to its design as a rigid rod, the heating element 18 can easily be introduced into and removed from the bored hole 14, for example, when replacing the heating element 18.

The inherently stable resilient hose 22 is positioned along the rod-shaped heating element 18 and is firmly connected to a free end of the heating element 18. As a result of this design, the hose 22 together with the heating element 18 can in one simple work step be introduced into and removed from the bored hole 14 of the sliding contact rail 10.

The hose 22 can be sealed off at one end, and the sealed-off end of the hose 22 can be connected to a free end of the rod-shaped heating element 18. This design allows the inner volume of the hose 22 to be evacuated at its other free end so that the outer diameter of the hose 22 is decreased during the evacuation. As a result of the firm connection of the sealed end to one of the free ends of the heating element 18, the hose 22 together with the heating element 18 can easily be inserted in its evacuated state into the bored hole 14, shifted, and then pulled out.

The bored hole 14 in the sliding contact rail 10 can be formed so close beneath the surface of the sliding contact rail 10 that a slit is formed by a section of the bored hole 14. The width of the slit is selected to be smaller than the diameter of the heating element 18 so that the heating element 18 can reliably be held in the bored hole 14. The clamping device 20 in the bored hole 14 is arranged on the side of the heating element 18 opposite the slit so that the clamping device 20 presses the heating element 18 in the direction of the slit. A portion of the section of the heating element 18 that is exposed at the slit can protrude out of the slit so that the portion protruding out of the slit can be in direct contact with the current carrying line 4.

Alternatively, the bored hole 14 in the sliding contact rail 10 can be formed so far beneath the surface of the sliding contact rail 10 that is turned toward the line 4 that the bored hole 14 is disposed completely within the sliding contact rail 10, but preferably in the vicinity of the surface of the sliding contact rail 10 that is turned toward the line 4.

According to a second aspect, the invention provides a heating device for the heatable current collector 2 described above. The heating device includes a substantially rigid, rod-shaped heating element 18 with an electrical resistance heating conductor and two free ends.

The heating element 18 further includes an inherently stable, resilient and thermostable hose 22 that is sealed off at one end. The sealed off end of the hose 22 is firmly connected to one of the free ends of the heating element 18. As explained above, the hose 22 can easily be introduced into the bored hole 14 due to its inherent stability. As a result of its resilience, the hose 22 takes on shape changes (expansion and contraction) of the heating element 18 that occur as a result of temperature changes. The resiliency of the hose 22 ensures that the heating element 18 is pressed against the inside surface 16 of the bored hole 14 so as to improve the heat transfer from the heating element 18 to the inside surface 16 of the bored hole 14 even for different shapes of the heating element 18 and at different temperatures. The thermostability of the hose 22 maintains its functionality even at the high temperatures that occur in the heating operation of the heating element 18. By sealing off the hose 22 at a free end, the inner volume of the hose 22 can be evacuated from its other free end so that the outer diameter of the hose 22 is decreased during the evacuation. The firm connection of the sealed off end to one of the free ends of the heating element 18 allows the hose 22 in the evacuated state to be introduced in a particularly easy way together with the heating element 18 into the bored hole 14 and removed therefrom.

The heating element 18 includes a rod 28 with an outer threading 34. The electric resistance heating conductor can be inserted into the grooves of the outer threading 34. As a result of the insertion of the resistance heating conductor into the grooves of the outer threading 34, the windings of the resistance heating conductor are connected to the rod 28 in a stable position with respect to the rod 28. Owing to its helical course, the outer threading 34 has a length that is much greater than the rod 28. A resistance heating conductor having a much greater length relative to the length of the rod 28 and a correspondingly greater heating capacity is thereby accommodated into the heating element 18. By making the rod 28 from Teflon, the rod 28 becomes thermostable and the outer threading 34 is easily formed in the relatively soft material (Teflon).

The outer side of the rod 28 with the electrical resistance heating conductor is coated with an electrically insulating and heat permeable layer 48. The insulating layer 48 is formed as an outer sheath of the heating element 18 and provides the heating element 18 with electrical insulation with respect to the outside. The electrical insulation provides protection to the person installing the heating device in the bored hole 14 of a sliding contact rail 10. The insulating layer 48 also permits the electric uncoupling of the heating device in the bored hole 14 from the electric current flowing in the sliding contact rail 10 during the operation of the current collector 2.

The electrically insulating and heat permeable layer 48 is designed as a shrink hose 50 that can easily be pulled in an expanded state over the rod 28 and subsequently shrunk. When the layer 48 is shrunk, it binds firmly to the rod 28, which is then enclosed by the layer 48. The electrically insulating and heat permeable layer 48 includes a layer made of PTFE for the electrical insulation with respect to high voltage.

At the two free ends of the heating element 18, the resistance heating conductor is connected in each case to an electrical feed line 38, i.e., to an electrical line for the current supply. The feed line 38 includes a high-voltage wire for feeding a heating current to the heating element 18 and an insulation layer that insulates sufficiently against the high voltage and the high current from the current carrying line 4. Several heating elements 18 or heating devices can be electrically connected one after the other (series connected) using such feed lines. The heating elements and heating devices that are electrically connected one after the other can be arranged axially one after the other in a bored hole 14 and/or they can be arranged in two or more bored holes formed parallel to one another. At the two free ends, the heating element 18 can be sealed off using silicone seals in order to protect against environmental and weather influences.

The heating element 18 can also include a reinforcement element, such as a strain relief device that extends in the longitudinal direction of the heating element 18. The reinforcement element is used to absorb mechanical stresses, particularly tensile stresses that act on the heating element 18. The reinforcement element is arranged within the insulating layer 48 or radially within the layer, for example, enclosed by the layer together with the rod 28. The feed lines 38 can also comprise suitable second reinforcement elements (strain relief elements). It is also possible to provide a strain relief device around a section in which one end of a feed line 38 is connected in an electrically conducting manner to an end of the resistance heating conductor.

The hose 22 of the clamping device 20 can be a silicone hose 22 that radially contracts and is flattened due to the application of a vacuum so that the heating device, i.e., the heating element 18 together with the clamping device 20 (the hose), can easily be introduced into a bored hole 14 in the sliding contact rail 10. If the vacuum is broken after the heating element 18 is introduced into the hole, then the hose 22 expands and pushes the heating element 18 against the inside surface 16 of the bored hole 14 opposite the hose 22. By mounting the heating element 18 in the bored hole 14 resiliently against the hose 22, the heating element 18 can reliably withstand the shocks and vibrations of the sliding contact rail 10 during operation. Furthermore, the heating device can easily be removed again from the bore, for example, during maintenance when a replacement heating device is installed.

Due to the helical arrangement of the resistance heating conductor in the grooves of the outer threading 34 of the rod 28, the rod-shaped structure of the heating element 18 reaches a maximized heating surface area, which in turn allows the operation at lower heating temperatures and for longer lifespans. Naturally, the materials incorporated in the heating device are robust and resistant with regard to the expected operating temperatures, even in the case of long lasting, continuous use.

A third embodiment involves a heatable current collector 2 that establishes an electrical contact between a current carrying line 4 and an electric vehicle 6. The current collector 2 includes a sliding contact rail 10 arranged substantially transversely to the current carrying line 4 and a lifting mechanism 8 on which the sliding contact rail 10 is mounted. The sliding contact rail 10 includes a bored hole 14 in which an electrically operated heating device is located that occupies only a portion of the cross section of the bored hole 14. The current collector 2 includes the heating device described above.

FIG. 1 shows the first embodiment of the invention in which a heatable current collector 2 establishes an electrical contact between a current carrying line 4 and the top side of an electric vehicle 6, for example, the roof of the vehicle. The current collector 2 includes a sliding contact rail 10 and a lifting mechanism 8. The sliding contact rail 10 is oriented substantially transversely to the current carrying line 4. The sliding contact rail 10 is mounted onto the lifting mechanism 8. The lifting mechanism 8 is attached by means of holding devices to the top side of the electric vehicle 6 and includes support arms hinged to one another. The lower hinged arms are pivotally attached to the holding devices, and the upper hinged arms are pivotally attached to the sliding contact rail 10. The top side of the sliding contact rail 10 is applied against the current carrying line 4 so that an electric contact is established between the sliding contact rail 10 and the line 4. Via a high current conductor (not shown) electrically connected to the sliding contact rail 10, electrical current flowing from the line 4 and into the sliding contact rail 10 is conducted by the sliding contact rail 10 for the operation of the electric vehicle 6.

A bored hole 14 is formed in the sliding contact rail 10 and extends in the longitudinal direction of the sliding contact rail 10. A heating device 12 is arranged in the bored hole 14. The heating device 12 includes an electrically operated, elongated heating element 18 and a clamping device 20. The elongated heating element 18 occupies only a portion of the cross section of the bored hole 14. The heating element 18 is connected to the clamping device 20, which presses the heating element 18 against the inside surface 16 of the bored hole 14.

Electrical current (heating current) is supplied to the heating device 12 through a first feed line 38, which leads out of the electric vehicle 6. The heating current is returned via a second feed line (not shown) back into the electric vehicle 6. The electric vehicle 6 houses a switching and control device (not shown) for switching on and off and for controlling the strength of the heating current supplied to the heating device 12.

The heating current is switched on if an ice or frost layer forms on the sliding contact rail 10 as a result of exposure to weather. The heating device 12 heats the sliding contact rail 10 and causes the ice or frost layer to melt. If the weather conditions are such that an ice or frost layer is likely to form on the sliding contact rail 10 during the operation of the electric vehicle 6, the heating current is switched on so that the heating device 12 heats the sliding contact rail 10, and the formation of an ice or frost layer on the heated sliding contact rail 10 is prevented. As a result of the contact of the sliding contact rail 10 with the line 4, heat energy generated by the heating device 12 can also propagate into the line 4 and contribute to the removal of any ice or frost layer formed on the line 4.

FIG. 2 shows a second embodiment of the invention in which the heatable current collector 2 includes two sliding contact rails 10 arranged one after the other in the direction of travel 56 of the electric vehicle. A bored hole 14 is formed in each sliding contact rail 10. Each bored hole 14 extends in the longitudinal direction of the sliding contact rail 10. A heating device 12 is arranged in each bored hole 14 in a similar manner to the heating device 12 of FIG. 1. The arrangement of two sliding contact rails 10 with heating devices 12 one after the other in the direction of travel 56 of the electric vehicle 6 also has the effect that the heating device in the front sliding contact rail 10 in the direction of travel 56 preheats the line 4, and the heating device in the rear sliding contact rail 10 in the direction of travel 56 then further heats the line 4, so that as an overall effect any ice or frost layer present on the line 4 can be removed even better.

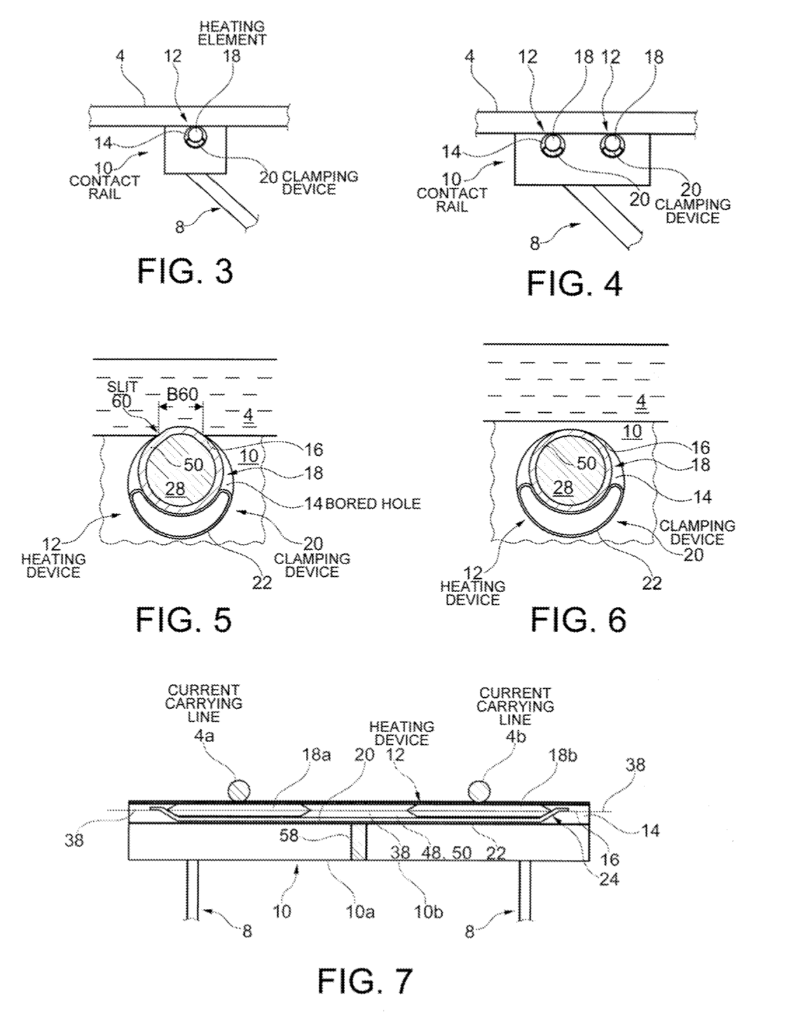

FIG. 3 is a cross sectional view of the sliding contact rail 10 if FIG. 2 in more detail shown perpendicular to the longitudinal direction of the sliding contact rail 10. The bored hole 14 is formed in the sliding contact rail 10 such that a slit or opening forms in the surface of the sliding contact rail 10. The heating device 12 is introduced into the bored hole 14 such that the clamping device 20 presses the heating element 18 up against the inside surface 16 of the bored hole 14 and into the slit.

FIG. 4 shows an embodiment of the sliding contact rail 10 similar to that shown in FIG. 3 except that two bored holes 14 are formed in the rail. As described above, a heating device 12 is arranged in each of the two bored holes 14. In a similar manner, additional bored holes 14 containing heating devices 12 can be used. Providing two or more heating devices 12 in the sliding contact rail 10 has the effect of doubling or multiplying the heating power entering the sliding contact rail 10, and thus results in an improved removal of the ice or frost layer.

FIG. 5 is a more detailed view of one implementation of the bored hole 14 of the embodiments of FIGS. 1 to 4. The bored hole 14 in the sliding contact rail 10 is formed so close beneath the upper surface of the sliding contact rail 10 facing the line 4 that a section of the bored hole 14 is open upward forming a slit 60. The slit 60 has a slit width B60 in the surface of the sliding contact rail 10 that faces the line 4. The clamping device 20 is arranged in the bored hole 14 on the side of the heating element 18 opposite the slit 60 and pushes the heating element 18 in the direction of the slit 60. The width B60 of the slit 60 is smaller than the diameter of the heating element 18 so that the heating element 18 is held securely in the bored hole 14. A section of the sheath surface of the heating element 18 lies exposed in the slit 60. The remaining portion of the sheath surface of the heating element 18 is located within the bored hole 14. Portions of the sheath surface of the heating element 18 that are opposite the clamping element 20 are pressed against the inside surface 16 of the bored hole 14 at the two sides of the slit 60. This direct compressive contact between the heating element 18 and the edges of the inside surface 16 produces a good heat transfer from the heating element 18 into the sliding contact rail 10 or its material. A portion of the heating element 18 that lies exposed at the slit 60 protrudes out of the slit 60. This protruding portion of the heating element 18 is in direct contact with the line 4 and achieves a good heat transfer from the heating element 18 to the line 4.

FIG. 6 shows an alternative arrangement of the bored hole 14 and the heating device 12 of FIG. 5. In FIG. 6, the bored hole 14 in the sliding contact rail 10 is formed so far beneath the surface of the sliding contact rail 10 facing the line 4 that the bored hole 14 is completely within the sliding contact rail 10, and there is no slit 60. The alternative arrangement shown in FIG. 6 can be implemented with no problem in the embodiments of FIGS. 1 to 4.

FIG. 7 shows a third embodiment of the invention in which the current carrying line includes two current carrying lines 4a and 4b that run substantially parallel to one another. Accordingly, the sliding contact rail 10 is subdivided into two sections 10a and 10b in the direction transverse to the lines 4a and 4b by an insulation element 58 located substantially in the center of the sliding contact rail 10. The two sections 10a and 10b are electrically insulated from one another. The section 10a is used for establishing electrical contact with current carrying line 4a, and the section 10b is used for establishing electrical contact with the other line 4b. The bored hole 14 extends in the longitudinal direction of the sliding contact rail 10 and it extends through the first partial section 10a, the insulation element 58, and the second partial section 10b. The heating device 12 disposed in the bored hole 14 includes a first heating element 18a and a second heating element 18b. The first heating element 18a is located in the first section 10a of the sliding contact rail 10 and is used for heating section 10a and the first line 4a. The second heating element 18b is located in the second section 10b of the sliding contact rail 10 and is used for heating section 10b and the second line 4b. The first heating element 18a and the second heating element 18b are connected one after the other (i.e., in series) by means of sections of the electrical feed line 38.

The two heating elements 18a and 18b are arranged one after the other and enclosed by a common electrically insulating and heat permeable layer 48, which is continuous in the direction extending over the two heating elements 18a and 18b. The insulating layer 48 is formed as a shrink hose 50. The clamping device 20 is designed as an inherently stable, resilient and thermostable hose 22 and extends in the longitudinal direction along the two heating elements 18a and 18b. In this manner, the clamping device 20 pushes the two heating elements 18a and 18b against the inside surface 16 of the bored hole 14. At one end (on the right in FIG. 7), the hose 22 is sealed off and is firmly connected to the outer free end of the second heating element 18b. The embodiments of FIGS. 1 to 4 can be implemented with the contact rail 10 having two sections 10a and 10b arranged one after the other in the longitudinal direction and having a heating device 12 with two heating elements 18a and 18b electrically connected one after the other for establishing electrical contact with two current carrying lines 4a and 4b of a double line.

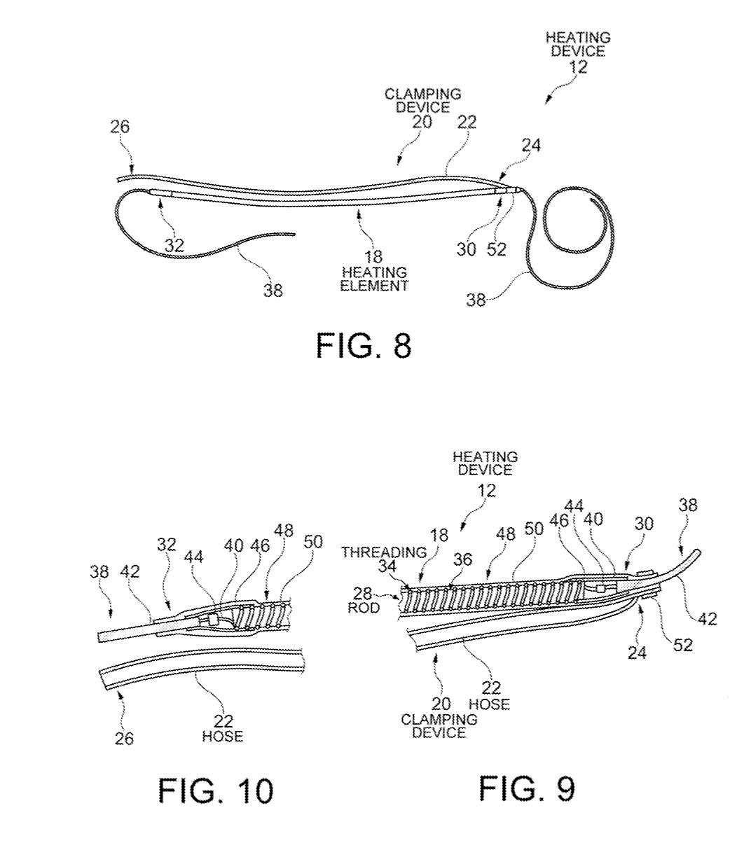

FIGS. 8 to 10 show an embodiment of heating device 12 that is preassembled and ready to install in a sliding contact rail 10 of a current collector 2. As shown in FIG. 8, the heating device 12 includes a substantially rigid rod-shaped heating element 18 with an electrical resistance heating conductor 36. The heating element 18 has two free ends 30 and 32. A current feed line 38 is electrically connected to each end. The heating device 12 also includes an inherently stable, elastic and thermostable hose 22. The hose 22 is sealed off at one end 24. The sealed off end 24 of the hose 22 is firmly connected to the free end 30 of the heating element 18. For establishing this connection, the sealed off end 24 of the hose 22 and the free end 30 of the heating element 18 are jointly wrapped with a wrapping element 54, such as an adhesive tape, for example.

As shown in FIGS. 9 and 10, the heating element 18 is formed by a rod 28 having an outer threading 34. The electrical resistance heating conductor 36 is inserted into the grooves of the outer threading 34. The rod 28 is preferably made of Teflon. The outer side of the rod 28 with the electrical resistance heating conductor 36 is enclosed by an electrically insulating and heat permeable layer 48. The layer 48 is used for the electrical insulation and for the protection of the resistance heating conductor 36 located in the grooves of the outer threading of the rod 28. In particular, the insulating layer 48 includes a shrink hose 50 on the outside. The layer 48 and the shrink hose 50 extends over the free ends 30 and 32 of the heating element 18 and in each case enclose the longitudinal sections where the ends of the resistance heating conductor 36 are electrically connected to respective electrical feed lines 38. Each feed line 38 is made from an inner, electrically conducting core wire 40 and an insulation layer 44 enclosing the core wire 40. The connection sections are each arranged in a protective sheath 46 that is used for supporting and for electrically insulating the connection section.

To connect an end of a feed line 38 to an end of the resistance heating conductor 36, a longitudinal section of the insulation layer 44 is removed so that the core wire 40 is exposed. Then the exposed core wire 40 is connected in an electrically conducting manner to the end of the resistance heating conductor 36 using a connection element 44 that has a luster terminal and/or a fuse. A protective sheath 46 is shifted in each case over the connection sections formed at the two free ends 30 and 32 of the heating element 18. After the two ends of the resistance heating conductor 36 are connected, the insulating layer 48 is pulled over the connection section at the free end 30, over the rod 28 with the heating resistance conductor 36 in the grooves of the outer threading 34, and over the connection section at the other free end 32 of the heating element 18. Subsequently, a shrink hose 50 in its expanded state is pulled and shrunk over the connection section at the free end 30, over the rod 28, and over the connection section at the other free end 32 of the heating element 18. In a section in which the insulating layer 48 and the shrunk hose 50 enclose the insulating sheath 42 of the feed line 38, the sealed off end 24 of the hose 22 is attached to the free end 30 of the heating element by wrapping a wrapping element 54, such as an adhesive tape, around the sealed off end 24 of the hose 22 together with the aforementioned section.

In order to install the resulting premounted heating installation 12 into a prefabricated sliding contact rail 10 of a current collector 2, the bored hole 14 in which the heating device 12 is to be accommodated is first produced as a through hole in the longitudinal direction of the sliding contact rail 10. For the embodiment shown in FIG. 5, the hole 14 is formed so as to produce the slit 60 in the surface of the sliding contact rail 10 facing the current carrying line 4.

Then the hose 22 is evacuated from its open second end opposite from the sealed off first end 24. Thus, the air contained in the inner space of the hose 22 is pumped out and a low pressure is generated. The heating device 12 with the feed line 38 connected at the free end 30 to the sealed off end 24 of the hose 22 is then pushed into the bored hole 14 until the feed line 38 and the free end protrude at the opposite end of the bored hole 14. If necessary, the heating device 12 in the bored hole 14 is rotated about its the longitudinal axis until the heating element 18 is located at the desired position on the inside surface 16 of the bored hole 14, such as against the slit 60. The evacuation of the inner space of the hose 22 is terminated so that the hose 22 expands owing to its resilience. The heating element 18 is pressed against the inside surface 16 of the bored hole 14 and pushes partially through the slit 60 as shown in FIG. 5.

A heatable current collector for establishing an electrical contact between a current carrying line and an electric vehicle includes a sliding contact rail arranged substantially transversely to the current carrying line. The sliding contact rail includes a bored hole in which an electrically operated, elongated heating element is disposed that occupies only a portion of the cross section of the hole. The heating element is connected to a clamping device that presses the heating element against the inside surface of the bore. The invention also includes a heating device for the heatable current collector. The heating device has a substantially rigid, rod-shaped heating element with an electrical resistance heating conductor and two free ends. The heating device also has an inherently stable, resilient and thermostable hose that is sealed off at one end. The sealed off end of the hose is firmly connected to one of the free ends of the heating element.

### LIST OF REFERENCE NUMERALS:

2 current collector
4 line
4a line of a double line
4b line of a double line
6 electric vehicle
8 lifting mechanism
10 sliding contact rail
10a section of contact rail
10b section of contact rail
12 heating device
14 bored hole
16 inside surface
18 heating element
20 clamping device
22 hose
24 first end
26 second end
28 rod
30 free end
32 free end
34 outer threading
36 resistance heating conductor
38 feed line
40 core wire
42 insulating sheath
44 connection element
46 protective sheath
48 layer
50 shrink hose
52 connecting means
54 wrapping element
56 direction of travel
58 insulation element
60 slit
B60 slit width

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-13. (canceled)

14. A device comprising:
a sliding contact rail with a bored hole disposed longitudinally through the sliding contact rail, wherein the bored hole has a cross section; and
a lifting mechanism on which the sliding contact rail is mounted, wherein an elongated heating element occupies only a portion of the cross section of the bored hole, wherein the elongated heating element is attached to a clamping device that presses the elongated heating element against an inside surface of the bored hole, and wherein the elongated heating element is electrically operated.

15. The device of claim 14, wherein the elongated heating element is formed around a rod.

16. The device of claim 15, wherein the elongated heating element includes an electrical resistance heating conductor helically arranged in grooves of an outer threading of the rod.

17. The device of claim 14, wherein the clamping device is a resilient hose.

18. The device of claim 17, wherein the resilient hose is disposed along the elongated heating element and is connected to an end of the elongated heating element.

19. The device of claim 17, wherein the resilient hose is sealed off at one end, and wherein the sealed off end of the resilient hose is connected to an end of the elongated heating element.

20. The device of claim 14, wherein the sliding contact rail has a surface adapted to face a current carrying line for an electric vehicle, and wherein the bored hole in the sliding contact rail is formed so close beneath the surface facing the line that a section of the bored hole forms a slit in the surface facing the line.

21. The device of claim 20, wherein the slit has a width that is smaller than the diameter of the elongated heating element.

22. The device of claim 20, wherein the clamping device pushes the elongated heating element towards the slit.

23. The device of claim 14, wherein the clamping device is disposed in the bored hole opposite the elongated heating element.

24. A device comprising:
a rod-shaped heating element with an electrical resistance heating conductor; and
a resilient hose that is sealed off at one end, wherein the sealed off end of the resilient hose is connected to an end of the heating element, and wherein the heating element and the resilient hose are adapted to fit inside a bored hole in a sliding contact rail.

25. The device of claim 24, wherein the heating element is made of Teflon.

26. The device of claim 24, wherein the electrical resistance heating conductor is disposed in grooves of an outer threading of the heating element.

27. The device of claim 24, further comprising:
an insulating layer covering the rod-shaped heating element, wherein the insulating layer is electrically insulating and heat permeable.

28. The device of claim 27, wherein the insulating layer is a shrink hose.

29. A device comprising:
a sliding contact rail with a hole disposed longitudinally through the sliding contact rail, wherein the hole has a cross section;
a lifting mechanism on which the sliding contact rail is mounted;
a rod;
an electrical resistance heating conductor disposed in grooves of an outer threading of the rod; and
a resilient hose that is sealed off at one end, wherein the sealed off end of the resilient hose is connected to an end of the rod, wherein the rod, the electrical resistance heating conductor and the resilient hose are disposed in the hole, wherein the rod and the electrical resistance heating conductor occupy only a portion of the cross section of the hole, and wherein the resilient hose presses the rod and the electrical resistance heating conductor against an inside surface of the hole.

30. The device of claim 29, wherein the resilient hose is disposed in the hole opposite the rod.

31. The device of claim 29, wherein the sliding contact rail has a surface adapted to face a current carrying line for an electric vehicle, and wherein the hole in the sliding contact rail is formed so close beneath the surface facing the line that a section of the hole forms a slit in the surface facing the line.

32. The device of claim 31, wherein the slit has a width that is smaller than the diameter of the rod.

33. The device of claim 31, wherein the resilient hose pushes the rod towards the slit.
